(19) United States
(12) Patent Application Publication
(10) Pub. No.: US 2004/0250683 A1
(43) Pub. Date: Dec. 16, 2004

(54) Advanced filtration devices and methods

(75) Inventors: David S. Soane, Piedmont, CA (US); Christopher D. Tagge, San Carlos, CA (US)

Correspondence Address: OSTROLENK, FABER, GERB & SFFEN, LLP, 1180 Avenue of the Americas, New York, NY, 10036-8403, US

(73) Assignee: Innovative Construction and Building Materials, LLC

(21) Appl. No.: 10/835,555

(22) Filed: Apr. 28, 2004

Related U.S. Application Data
(63) Continuation-in-part of application No. 10/273,609, filed on Oct. 18, 2002.
(60) Provisional application No. 60/466,160, filed on Apr. 28, 2003.
(60) Provisional application No. 60/542,409, filed on Feb. 5, 2004.

(51) Int. Cl. B01D 46/00

(52) U.S. Cl. 96/226; 55/524; 55/528

(57) ABSTRACT

A filter media comprises a medium for capturing and neutralizing harmful substances. Methods for fabricating a low-pressure, high efficiency filter media for capturing harmful substances produce filter media having engineered pores that have an engineered pour size dispersion, which may be monodispersed and uniformly arranged. Neutralizing components may be coated on filter media, providing both increased capture efficiency and neutralization of at least one harmful substance, such as harmful pathogens, aerosols, particulates, VOCs, gases and vapors.

### CROSS REFERENCE TO RELATED APPLICATIONS

This application is a continuation-in-part of U.S. application Ser. No. 10/273,609, entitled “Anti-Pathogenic Air Filtration Media and Air Handling Devices Having Protective Capabilities Against Infectious Airborne Microorganisms” to David S. Soane and Christopher D. Tagge, filed Oct. 18, 2002, which, in turn, claims the benefit of U.S. Provisional Application No. 60/454,794, filed Mar. 13, 2003, which is incorporated in its entirety by reference herein. This application claims the benefit of U.S. Provisional Application Nos. 60/542,409, entitled “Advanced Filtration Devices and Methods” to David S. Soane and Christopher D. Tagge, filed Feb. 5, 2004, and 60/466,160, entitled “Rapid Production of Sheet Filter Medias By Direct Casting and Imprinting,” to David S. Soane, filed Apr. 28, 2003, which is incorporated herein by reference in its entirety.

### FIELD OF THE INVENTION

The field of the invention is filtration, particularly filtration with neutralization or remediation of harmful particles, aerosols, vapors and gases.

### BACKGROUND OF THE INVENTION

Harmful substances, such as toxins and pathogens, are present in the air, which may cause illness in excessive concentrations. There are many sources for these harmful substances, which may be carried long distances or may be confined to an indoor environment. Indoor air pollution is a serious concern. For example, toxic mold has become a concern for homeowners and businesses. In addition, recent events make the possible use of pathogens and toxins, as a weapon of terror, a serious concern. The term harmful substances is meant to include natural substances, such as dust, mold toxins and pollens, manmade substances, such as smoke and volatile organic compounds, and terror weapons, such as VX, sarin, ricin and anthrax. The chemical formulas for four harmful substances are shown in FIGS. 1A-1D.

Some toxic chemicals are highly reactive polar compounds. For example, four categories of known chemical weapons include choking agents, blister agents, blood agents and nerve agents. Choking agents, such as chlorine and phosgene, attack the lungs. Blister agents, such as mustard gas (HD), are volatile liquids that blister organic tissue when absorbed on the skin, in the eyes, or within the lungs. Blood agents, such as hydrogen cyanide (HCN), are absorbed through the lungs into the blood, or via the intestines in the case of water born HCN, where it irreversibly binds to hemoglobin and prevents the uptake of oxygen. Nerve agents, such as sarin (GB), soman (GD), and VX, are extremely potent and deadly when inhaled or adsorbed through the skin or lungs. Chlorine, phosgene, and hydrogen cyanide are gases. GB, GD, VX, and HD are semi-volatile liquids that are commonly dispersed as an aerosol or a combination of gas and aerosol.

The decontamination of surfaces after exposure to toxic substances has been studied. The predominant decontamination strategies are adsorption (followed by incineration) and neutralization by chemical reaction. While the structures and functions of these toxic chemicals vary widely (FIGS. 1A-1D), all are highly reactive materials, which may be quickly neutralized by the right combination of reagents. For example, toxic chemicals may react rapidly with oxidizing agents, alkaline solutions, or both. Nerve agents undergo rapid oxidation to phosphoric acid in the presence of strong oxidants. HD also undergoes oxidation, although care must be taken to avoid partial oxidation to the substantially less toxic but still dangerous sulfone derivative. Hydrogen cyanide, chlorine, phosgene, HD, Sarin, Soman, and VX are all attacked rapidly by alkaline solutions to yield relatively benign products.

Volatile organic compounds (VOC) are prevalent throughout residential and commercial buildings and have been found to cause serious health consequences for occupants. While national and international health-related agencies have varied classifications, VOCs are widely recognized as compounds that are gaseous or have a significant vapor pressure at room temperature. For example, products such as particle board, plywood, fabrics, coatings, and insulation release significant amounts of gaseous formaldehyde, a common VOC. Peak concentrations of formaldehyde in homes and workplaces typically range from 0.04-0.4 ppm. Regular exposure to peak concentrations greater than 0.06 ppm may result in serious health consequences including mucosa irritation, rash, severe allergic reactions, fatigue, headache, nausea, depression, and a significantly increased risk of throat cancer with chronic, long-term exposure. Other VOCs commonly released from products in the home are benzene, toluene, styrene, acetone, para-dichlorobenzene, chloroform, tetrachloroethylene, acrylic acid esters, and aliphatic ketones and alcohol. In addition, building occupants are often exposed to low levels of other toxic gases including volatile sulfur complexes, and ammonia gas. Most VOC's may be neutralized by oxidizing agents, alkaline solutions or both.

Air filtration systems of air handling systems in buildings, vehicles and personal protective equipment are intended to improve the safety and/or quality of the air we breath. However, such filtration systems as those used in heating, ventilating and air conditioning (HVAC) systems are not capable of preventing harmful concentrations of microbes, particles, vapors and gases from dispersing throughout a structure. See Table I for a comparison of the size of some common harmful substances. Air filtration systems in vehicles aren't capable of reducing ordinary vehicle emission exhausts to safe levels, much less any unexpected release of harmful substances in the vicinity of a vehicle. Even personal protective equipment that is designed to prevent exposure to harmful substances has severe limitations on the duration of exposure permitted before replacement of filtration elements is required to guarantee continued protection.

In one example, concentrations of formaldehyde can exceed levels that may cause harm to human health merely from natural and manmade sources. Few HVAC systems can afford to neutralize such a substance. Indeed, HVAC systems are more likely to spread intentionally released toxins throughout a building rather than affording occupants any protection.

High Efficiency Particulate Air (HEPA) filters may be effective in trapping airborne pathogens and particles. If used, these filters might offer some limited, passive defense against some harmful substances, such as anthrax.

HEPA filters are ineffective against many other harmful substances, including most volatile organic compounds (VOC's) and other harmful substances in vapor, aerosol or gas form. Also, HEPA filters are highly efficient in capturing particles, but HEPA filters offer a concomitantly high cost of operation, which is related to the large resistance to airflow through the HEPA filter. The resistance to air flow, which may be measured as a pressure drop, requires more energy to be used in circulating air through the filters, which increases operating costs. Furthermore, the pressure drop across HEPA filters creates a high back pressure, which may lead to leaks in the HVAC conduits, dramatically lowering overall capture efficiency of the system.

Granular activated carbon filters, such as those used in conventional gas masks, are known to provide short-term protection from harmful gases. Activated carbon filters suffer from several limitations that have prevented their widespread adoption in HVAC applications and that reduce their effectiveness in personal protection applications, such as filters in protective masks. Specifically, the mechanism of gas adsorption in activated carbon is reversible. Thus, the absorbed gas may be released by changes in temperature, humidity or the chemical composition of the air. For example, the presence of a second gas with a higher affinity for the granular activated carbon can cause release of a previously absorbed gas. Additionally, activated carbon, which is non-polar, shows relatively poor adsorption of polar gases. These limitations mean that a comparatively high density of activated carbon is necessary to provide a reasonable filter lifetime. As discussed in relation to HEPA filters, this high density results in a large pressure drop across the filter, which is not desirable in a filtration system. Finally, granular activated carbon, which is held loosely in a filter bed, is susceptible to the formation of open channels, which significantly reduces the efficacy of the filter. U.S. Pat. No. 6,435,184, which is hereby incorporated by reference, discloses the structure of a conventional protective mask, for example.

U.S. Pat. No. 3,017,329 issued in 1962 and disclosed a germicidal and fungicidal filter using a conventional non-woven filter medium. The filter medium is coated by conventional process, such as by spraying or bathing the filter medium using an active ingredient. The active ingredient was selected from organo silver compounds or organo tin compounds, which have a neutral pH, but are highly toxic to mammals. The treated filter is then heated to drive off water, which was used as a solvent in the coating process and to cure a binder that fixes the active ingredient to the filter medium.

U.S. Pat. No. 3,116,969 describes a filter having an alkyl aryl quaternary ammonium chloride antiseptic compound, which is held to conventional filter fibers by a tacky composition that includes a hygroscopic agent, a thickening agent and a film forming agent.

U.S. Pat. No. 3,820,308 describes a sterilizing filter having a wet oleaginous coating containing a quaternary ammonium salt as the sterilizing agent.

M. Dever et al. Tappi Journal 1997, 80(3), 157 discloses the results of a study of the antimicrobial efficacy of an antimicrobial agent incorporated into fibers of a melt-blown polypropylene filter medium. Each of three different, unidentified agents were blended with polypropylene, which was then melt-blown conventionally to form a filter medium. Only two of the agents were detectable by FTIR after processing, and these two agents provided antimicrobial properties. However, the agents negatively affected the physical properties of the polypropylene, causing thickening of the fibers of the filter medium and reduced collection efficiencies than unblended polypropylene.

K. K. Foard and J. T. Hanley, ASHRAE Trans., 2001, v.107, p.156 discloses the results of field tests using filters treated with one of three unidentified antimicrobial agents. Known antimicrobial filter treatments produced little effect under the test conditions, showing growth on both untreated and treated counterparts alike.

A. Kanazawa et al., J. Applied Polymer Sci., 1994, v.54, p.1305 discloses an antimicrobial filter medium using covalently immobilized antimicrobial phosphonium chloride moieties onto a cellulose substrate. Phosphonium salts with longer alkyl chains tended to have a higher capacity for capturing bacteria.

M. Okamoto, Proceedings of the Institute of Environmental Sciences and echnology, 1998, p.122 discloses the use of silver zeolite as an antimicrobial agent in an air handling filter. The silver zeolite is attached by a binder to one side of the filter.

U.S. Pat. Publ. No. 2001/0045398 discloses a process for the preparation of non-woven porous material having particles immobilized in the interstices thereof. The particles are added by contacting the material with a suspension of particles and forcing the suspension through the material, capturing the entrained particles in the interstices of the porous material and providing an antimicrobial barrier.

The English language abstract of International Publ. No. WO 00/64264 discloses a bactericidal organic polymeric material for filters that is made of a polymer base comprising a backbone and a polymeric pendant group bonded to the backbone. The material comprises units derived from an N-alkyl-N-vinylalkylamide and triiodide ions fixed to the polymeric material.

International Publication No. WO 02/058812 discloses a filter medium containing time release microcapsules of antimicrobial agent. The microcapsules contain the agent suspended in a viscous solvent, which slowly diffuses out of the porous shell of the microcapsule. The microcapsule may be held to conventional filter medium using gum Arabic as an adhesive.

Other methods of removing airborne pathogens includes percolating air through a liquid, electrostatic precipitation (e.g. U.S. Pat. No. 5,993,738), ultraviolet light (e.g. U.S. Pat. No. 5,523,075), but each of these uses significantly more energy than is acceptable for high volume HVAC applications.

All of the previous examples have shortcomings that prevent their widespread adoption in air filtering systems, such as producing hazardous waste disposal problems, having high operating costs and having high costs for production and maintenance of the filtration systems. Thus, there is an urgent need for substantial improvement in the protective capabilities of low-cost and effective filters. Low energy consumption is particularly needed in the capture and neutralization of harmful particles, pathogens, aerosols, vapors and gases.

Generating submicron patterns may be achieved using photolithographic processes, as is known in the art of semiconductor device fabrication, such as the process disclosed by U.S. Pat. No. 5,110,697, which is incorporated herein by reference. Generating 1-50 micron patterns is easily achieved by well-known, conventional processes using photolithography and other conventional techniques, such as color printing and embossed sheet printing. In color printing, processes for registering precise positioning of multiple layers is well known. Also, embossed sheet formation is known that provides durable patterned roller surfaces in processing molten viscous fluids or softened solids. For example, in forming embossed sheets, a polymer melt is squeezed through a narrow gap, known as the nip region, of a set of calender rolls with embedded surface features. These processes, which are not related to the fabrication of conventional filter medium, are referred to herein as conventional substrate printing methods.

### SUMMARY

A filter comprises a medium for capturing and neutralizing harmful substances. A low-pressure, high efficiency pre-filter may be used to capture particles prior to entry into a filter medium. The advanced filter medium comprises a filtration component and a neutralization component. The neutralization component is a film of viscous organic components and reactive components coated in a thin film on a substrate, providing low-pressure-drop, high-throughput remediation of harmful substances.

In one embodiment, a neutralization component is supported by a filtration component, such as fibers, which supports the neutralization component. The fibers are distributed in the filter such that air passing through the filter must pass through tortuous channels around the fibers. Thus, harmful substances entrained in the air contact the neutralization component, which neutralizes one or more of the harmful substances.

### BRIEF DESCRIPTION OF THE DRAWINGS

FIGS. 1A-1D show the chemical formula for several toxic substances.

FIG. 2 illustrates one embodiment of the invention having fibers coated by a remediation layer.

FIG. 3 shows one embodiment of a broad spectrum filter for remediation of a plurality of toxic or harmful substances.

FIG. 4 shows filter fibers without a remediation layer.

FIG. 5 illustrates fibers coated with a remediation layer that is sprayed with a solution containing mold spores after being placed in an incubator at temperature and humidity suitable for mold growth.

FIG. 6 illustrates the fibers of FIG. 4 that are similarly coated and incubated, as in FIG. 5, showing substantial mold growth compared to the embodiment illustrated in FIG. 5.

FIG. 7 shows actual fibers of a filter according to the prior art.

FIG. 8 illustrates a filter comprising a coarse pre-filter, a neutralizing component coating the coarse pre-filter, and a sheet filter medium.

FIG. 9 illustrates the concept of fiber wrapping, which means placing a layer or layers of functional polymer on the surface of a fiber, providing a remediation layer.

FIG. 10 illustrates one embodiment of a sheet filter medium.

FIG. 11 shows a method of preparing a sheet filter medium.

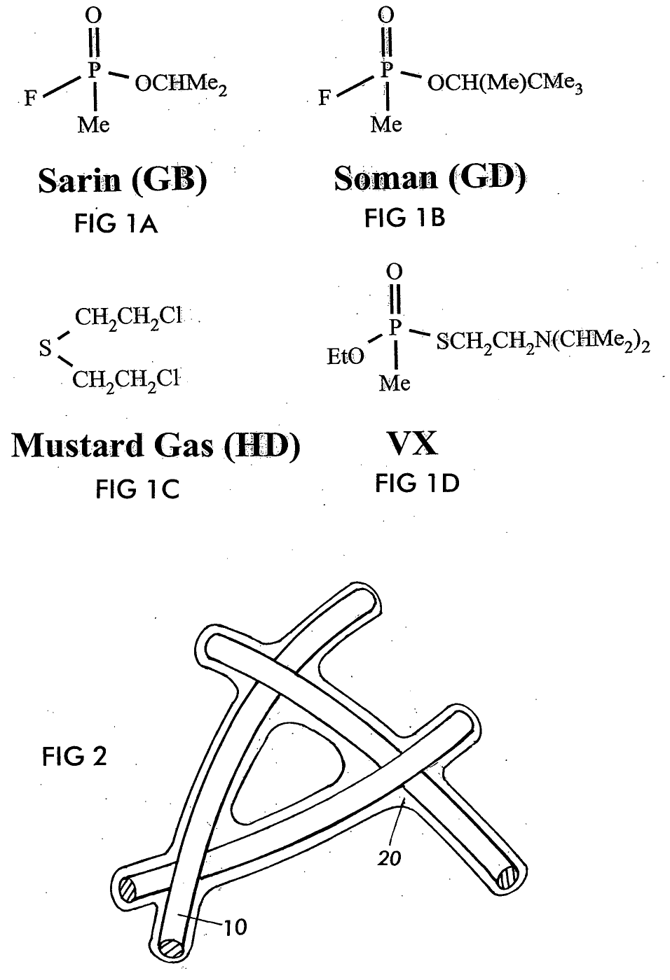

### DETAILED DESCRIPTION

In one embodiment, a filter comprises a filtration component and a neutralization component. The filtration component may be comprised of several distinct layers of filtration medium or may be continuous. Regardless, the neutralization component may be a single active agent, a combination of active agents or may be a plurality of active agents striated into separate areas in the filtration component.

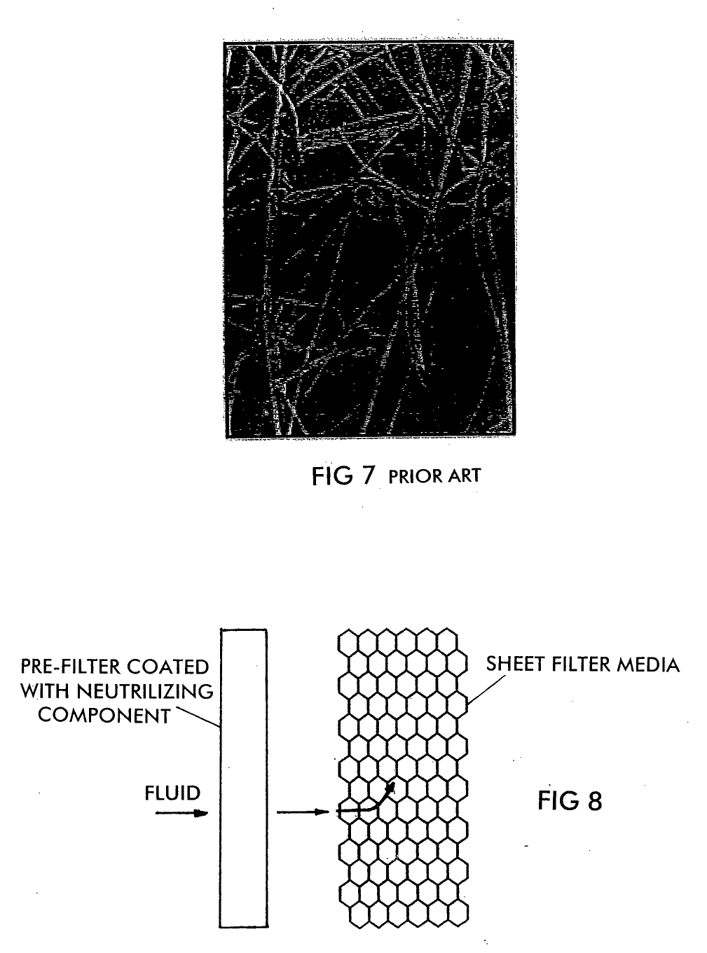

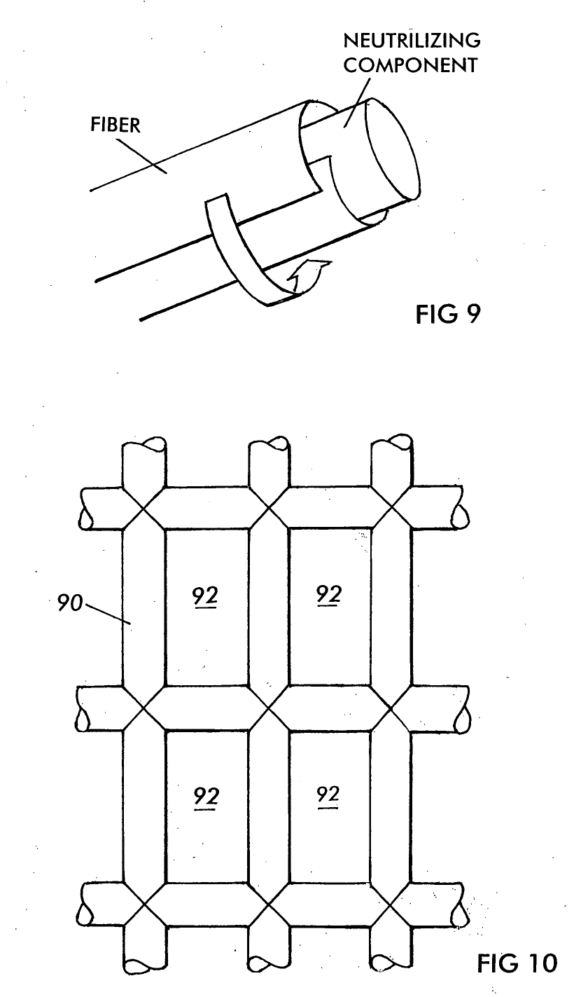

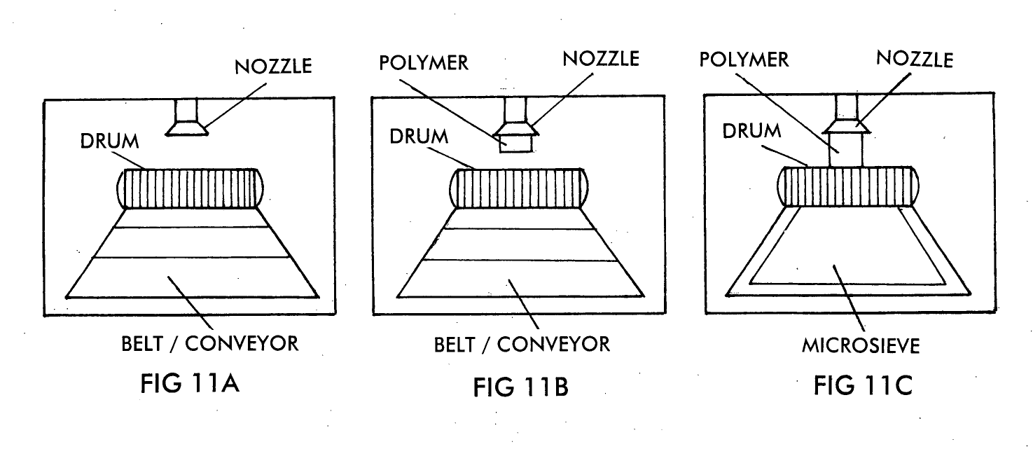

For example, the neutralization component is supported by the filtration component, as shown in FIG. 2, which acts as a substrate for the neutralization component. Conventional filtration media use randomly intertwined and/or entangled fibers, as shown in FIG. 7, that cause air passing through the filter to pass through tortuous airways between the fibers. The fibers are distributed in the filter such that air passing through the filter must pass through tortuous channels around the fibers. Thus, harmful substances entrained in the air contact the neutralization component, which neutralizes one or more of the harmful substances.

In one example, a filter for neutralizing of harmful substances comprises a conventional, non-reactive filter media, such as polymer fibers, coated with a remediation layer. The remediation layer comprises a host material that harbors one or more neutralizing substances, such as acidic, basic or oxidizing substances. The host material may have a tacky surface that sticks to entrained particles that impact on the tacky surface, improving the efficiency of particle capture, and allowing additional time for neutralization of the particles, such as pathogens.

Coating fibrous filters with thin layers of viscous organic components in a remediation layer is found to adsorb organic gases and aerosols. High-throughput filter media are equipped with reactive coatings tailored to efficiently capture and neutralize toxic and harmful substances, such as pathogens, VOC's and other chemicals. The reactive coatings comprise reactive components to neutralize toxic or harmful substances and a coating matrix that provides adhesion between the reactive component to the filter media.

Examples of reactive components are oxidizing agents, such as sodium hypochlorite, calcium hypochlorite, and potassium permanganate; acidic complexes, such as acrylic acid derivatives and sulfonic acid derivatives; and basic complexes such as sodium alkoxides, tertiary amines, and pyridines and compatible mixtures thereof.

The matrix component is typically a polymeric material such as poly(vinyl pyrrolidone), poly(vinyl pyridine), poly(acrylic acid) (free acid or salt), poly(styrene sulfonic acid) (free acid or salt), poly(ethylene glycol), poly(vinyl alcohol), polysiloxanes, polyacrylate derivatives, carboxymethyl cellulose, and mixtures and copolymers thereof. In some cases, such as poly(styrene sulfonic acid) the matrix component may also act as the reactive component. The matrix component may also consist of non-volatile, low molecular weight complexes, such as glycerol and ethylene glycol oligomers, to promote affinity to the target toxic or harmful substance.

The polymer component may also be crosslinked to prevent removal of the reactive coating from the filter fiber under extreme conditions. The reactive coating technology is applicable to any fibrous filter media including glass and synthetic polymer fibers such as polyester and cellulose derivatives.

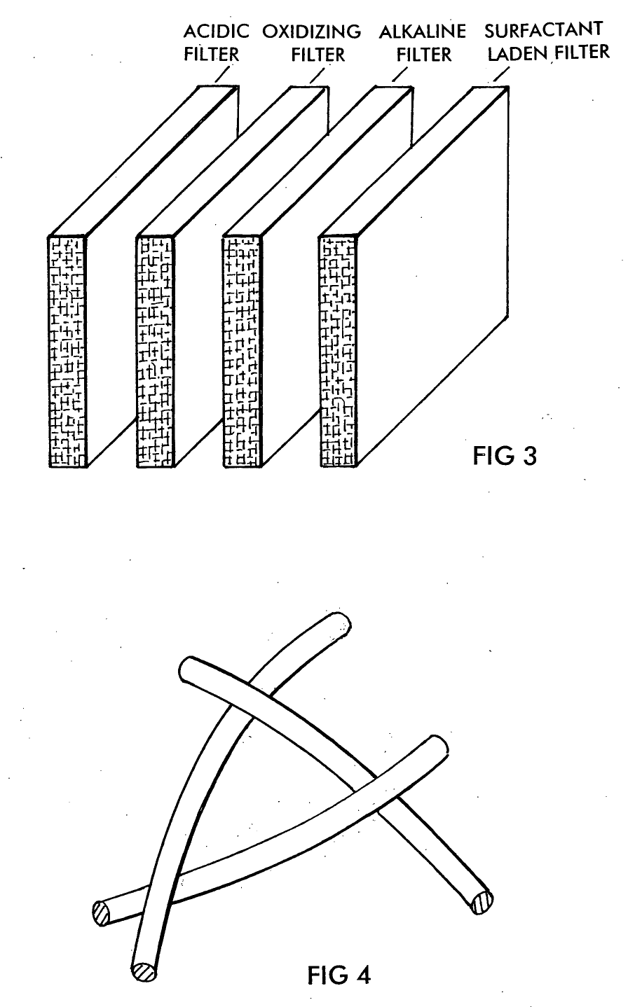

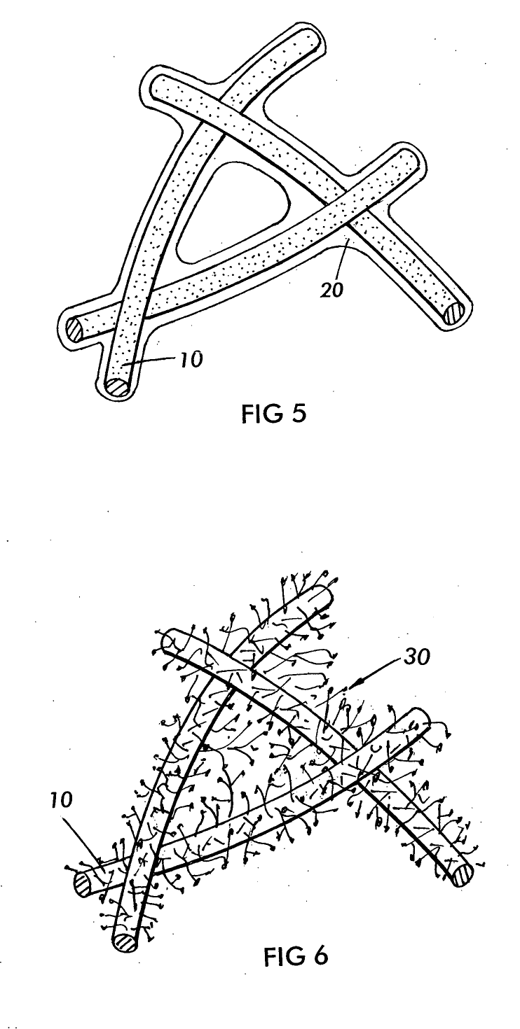

One advantage of these highly efficient filters is the high probability of remediation of the toxic or harmful substance or substances. This is a function of the filter structure, which preferably causes a large number of collisions between the toxic or harmful substances and the filter media, and the probability that each collision with the filter media will result in adsorption or neutralization. No single set of conditions is universally applicable to all substances. Thus, for a multiphasic filtration, a multiple environment, broad spectrum filter may be desirable as shown in FIG. 3, for example.

The following examples of the neutralizing component each provide protection against specific harmful substances as reported; however, other harmful substances may also be neutralized that were not tested.

### EXAMPLE 1

Formation of an Oxidizing Gel Coating

An aqueous solution is made of the following: 20 wt. % tetraethoxysilane, 20 wt. % bis(triethoxysilyl)methane, 10 wt. % glycerol, and 0.05 wt. % citric acid. A fiber glass pad is dipped in the above solution, blotted, and then cured by steam heating for 6 h. The pad is then dipped in an aqueous solution of 2% sodium hypochlorite and 0.5% cyanuric acid and then dried. The resulting filter was effective for the neutralization of diethyl sulfide.

### EXAMPLE 2

Formation of an Oxidizing Coating

An aqueous solution is made of 10 wt % poly(vinyl pyrrolidone). A fiber glass pad is dipped in the above solution, blotted, and then irradiated under a UV lamp for 6 h to crosslink the polymer. The pad is then dipped in an aqueous solution of 2 wt % calcium hypochlorite and air dried. The resulting filter was effective for the neutralization of formaldehyde.

### EXAMPLE 3

Formation of an Oxidizing Coating

An aqueous solution is made of 10 wt % poly(vinyl pyrrolidone) and 2 wt % potassium permanganate. A fiber glass pad is dipped in the above solution and then air dried. The resulting filter was effective for the neutralization of formaldehyde.

### EXAMPLE 4

Formation of an Oxidizing Coating

An aqueous solution is made of 10 wt % poly(vinyl pyrrolidone). A fiber glass pad is dipped in the above solution, blotted, and then irradiated under a UV lamp for 6 h to crosslink the polymer. The pad is then dipped in an aqueous solution of 2% potassium permanganate and air dried. The resulting filter was effective for the neutralization of formaldehyde.

### EXAMPLE 5

Formation of an Oxidizing Coating

An aqueous solution is made of 10 wt % poly(ethylene glycol) and 2 wt % calcium hypochlorite. A fiber glass pad is dipped in the above solution and air dried. The resulting filter was effective for the neutralization of formaldehyde.

### EXAMPLE 6

Formation of an Oxidizing Coating

An aqueous solution is made of 10 wt % poly(acrylic acid) sodium salt and 2 wt % calcium hypochlorite. A fiber glass pad is dipped in the above solution and air dried. The resulting filter was effective for the neutralization of formaldehyde.

### EXAMPLE 7

Formation of an Alkaline Coating

An aqueous solution containing 30 wt % glycerol, 5 wt % polyethylenimine and 0.25 wt % glycerol propoxylate triglycidyl ether. A glass pad is immersed in the solution, blotted dry and cured at 100 C for 6 hours. The glass pad is then immersed in an aqueous sodium hydroxide solution of pH 12 or greater containing 30 wt % glycerol, removed from the solution, blotted dry and dried at 50 C for two hours. The resulting filter was effective for the neutralization of hydrogen cyanide gas.

### EXAMPLE 8

Formation of an Acidic Coating

An aqueous solution is made of the following: 30 wt % glycerol, 5 wt % styrene sulfonic acid, 0.1 wt % divinylbenzene, 0.13 wt % 2,2′-azobisisobutyronitrile, 0.02 wt % potassium persulfate, and 0.5 wt % sodium dodecyl sulfate. A fiberglass pad is dipped in the above solution, padded dry, and then cured at 85 C for 2 h. The resulting filter was useful for the neutralization of ammonia gas.

Method for Rapid Production of Sheet Filter Medium

FIG. 10 illustrates a partial, close-up view of a sheet filter medium having a uniform rectangular mesh of monodisperse pores. Monodisperse means that the pore size is substantially the same in at least a substantial portion of the sheet filter medium. More generally, the method may produce filter media having any desired distribution of pores. For example, FIG. 8 shows another filter medium having a honeycomb structure; however, any structure may be formed by the method for rapid production of sheet filter media.

One method of producing a filter having an engineered distribution of pores provides for rapid production of sheet filter medium by direct casting and imprinting. A conventional substrate printing method is used to form a two-dimensional or three-dimensional porous sheet filter medium. By “direct casting and imprinting,” it is meant that fibers of a two-dimensional or three-dimensional filter medium are in situ from precursors during the generation of the desired filter medium structure by a printing method. The process is distinguished from conventional embossing and papermaking, for example, by the formation of sub-micron and greater porous structures formed by the in situ fibrous pattern generation. The structure of the resulting filter medium is an organized and interconnected pattern of fibers. The interconnected pattern of fibers may be formed into a sheet filter medium that exhibits both strength and flexibility unavailable from conventional filter media.

It is believed, without being limiting in any way, that surface tension forces are responsible for causing a spontaneous segregation of a two-phase solution or emulsion of the polymer precursors and a solvent, for example, on a substrate with ridges having one surface tension and grooves having another surface tension. Thus, the pattern of the fibrous filter medium may be laid out by this separation on a printing substrate that is patterned using a conventional substrate printing method, such as photolithography, color-printing-like process or embossed sheet printing.

For example, an aqueous precursor emulsion is prepared for use with a photolithographically prepared printing substrate having a pattern of ridges and grooves on its surface. The emulsion is prepared such that at least one precursor phase surrounds the ridges and water fills the grooves. Alternatively, the opposite orientation of the precursor phase and the aqueous phase, or other solvent, containing the precursor phase may be selected by controlling the water-in-oil or oil-in-water nature of the multi-phase emulsion or solution. The precursor phase may contain substances that form fibers by polymerization, solidification, crystallization, catalytic growth from the vapor or any other consolidation process that retains the orientation provided by the pattern of ridges and grooves from the surface of the printing substrate.

For example, the precursor phase comprises polymer precursors that form polymer fibers in situ during phase separation on the ridges of the substrate surface. Then, the removal of the aqueous phase or solvent may be achieved by evaporation, for example, leaving well-defined voids of a particular size, shape and distribution in between strands of polymer that are interconnected in a the pattern of the ridges. A network of interconnected fibers is formed that define pores in the filter medium. The fibers may be coated by the neutralizing component to assist in capture an neutralization of harmful substance. In one example, the fibers are substantially coated by the neutralizing component, which provides for both efficient particle capture and adequate neutralization of harmful gases, such as volatile organic compounds (VOCs).

In another example, the precursor phase is dissolved or digested cellulosics or a proteinaceous polymer in an aqueous solution, and the aqueous solution is mixed with a solvent in an emulsion, which segregates to the ridges on the surface of a printing substrate. In this example, the precursor phase forms in situ in the grooves. The resulting fibers retain the pattern of the grooves, which may be any pattern. For example, the pattern forms a mesh, a honeycomb or any other two-dimensional geometric shape.

In one embodiment, the separation of the precursor phase from the aqueous or solvent phase is not attributed to dissimilar materials at the ridges and grooves on the surface of the printing substrate. Instead, the separation is caused by temperature differences between the material at the ridges and within the grooves, which drives spontaneous assembly of a precursor phase. In this specific example, the precursor feed need not even be a multiphase system. For example, pre-polymers or polymers may be selected that will form around comparatively cold features from a metastable solution, leaving solvent rich and stable solution in the comparatively warmer spots. Thus, a sheet filter medium may be formed from a non-aqueous polymer solution.

In another alternative, the surface of the printing substrate does not have ridges and grooves. Instead, the surface is substantially flat, and is comprised of a pattern of dissimilar materials, such as a pattern printed on the surface of a printing substrate. The dissimilar materials have differing surface tension forces with the emulsion or solution, which causes separation of the precursor phase and the aqueous or solvent phase. In this manner, a pattern of fibers may be formed from the printing substrate, as before.

In yet another example, the precursor phase comprises a polyester dissolved in an acrylated monomer/crosslinker/photo-initiator formulation, such as a polyethyleneteraphthalate plasticized by a benzylacrylate and bisphenol-A-diacrylate mixture. A roller surface is patterned by a conventional substrate printing method, and the roller is used to spontaneously initiate phase migration and self-assembly according to the pattern on the roller surface. A patterned sheet is formed that is then exposed to a strong UV light source, whereupon the acrylate formulation polymerizes to form an interpenetrating molecular network within the polyester fibers. Residual water or other solvent, if present, evaporates, leaving organic fibers in a strongly crosslinked and flexible sheet filter medium.

The polyester fibers are anchored firmly by the interpenetrating acrylic network, which ensures that the porous pattern that is formed by the roller is stable and permanent. Thus, the sheet filter medium has a pattern of pores with a constant size, distribution and spacing based solely on the pattern provided on the surface of the roller and the thickness of the strands of organic polymers. The pattern on the roller may have any pattern from submicron size to 50 microns for filtering applications. The strand thickness may be controlled by the amount of precursor component and the concentration of the precursor component in the diluent or solvent.

In another example, a partially polymerized fluorocarbon suspension in waster is subjected to contact with the surface of a roller having an embossed pattern of poly(tetrafluoroehtylene). The fluorocarbon material accumulates around the poly(tetrafluoroethylene) patterns, leaving water (or aqueous solution) in metal oxide regions of the roller surface. The patterned fluorocarbon is polymerized by a polymerization reaction, such as by applying heat or light, e.g. UV light. A very fine, lace like fluorocarbon filter medium is formed by his process.

Alternatively, polyester or nylon sheets are formed by the same process, except that partially polymerized precursors (or other percursors, such as blends of dead polymers and yet unreacted or partially reacted precursors) are used that form polyester or nylon. The polyester and nylon sheets also form lace like filter media. After a lace-like architecture is formed and polymerization is completed while mechanically stretching the sheet filter media in both orthogonal directions simultaneously. The stretching draws the fibers, uniformly decreasing the fiber diameter and increasing the pore size. This technique, which is applicable to other precursors, as well, enables the production of filter media having sub-micron fiber diameters, improving the capture efficiency versus pressure drop characteristics compared to larger fiber diameters.

In another alternative embodiment, hybrid processes use pre-spun fibers together with direct casting and imprinting to form filter media. For example, pre-spun parallel fibers may be fed into a calender that has embossed lines perpendicular to the direction of parallel fiber travel. A precursor-containing feed is contacted with the embossed surface, forming patterns of the precursor material over the parallel fibers. The precursor is reacted, forming sheet filter media in combination with the pre-spun fibers. In one example, ample voids exist between the “warp” and the “fill” yarns, i.e. the fibers formed in situ and the pre-spun fibers. The new fibers adhere to the pre-spun fibers, imparting strength to the hybrid filter medium. In addition, the focused overlap points allow the fibers to pivot, giving the material sufficient flexibility. As before, the new fibers may be porous or solid, synthetic or natural and simple in construction or a composite structure. The new fibers may possess a core-shell geometry by using organic-aqueous systems having at least two phases, where both phases contain polymers or precursors. Also, the pattern of the fibers may include wavy, curved or articulated lines deposited on the pre-spun fibers, which are not possible using conventional pre-spun fibers in the absence of casting and imprinting.

In yet another embodiment, an aqueous-organic-aqueous complex emulsion may be used to engineer porous strands. These porous strands surround voids, but also have voids within the strands that are formed during the evaporation of water formed within the strands by chemical affinity with the water or surface tension forces, for example. In one example, hydrophilic and hydrophobic moieties are used to produce such porous, polymer strands.

Patterns may be generated using the process of this invention that are difficult or impossible to reproduce otherwise in a low-cost, mass-producible filter medium. For example, a sheet filter medium is produced having at least one area with a monodisperse pore size. More preferably, the monodisperse pore size, shape and distribution is uniform over a large surface area of the sheet filter medium. The uniformity of the pore size is capable of greatly increasing the particle capture efficiency of the filter medium per fiber volume as compared to conventional, heterogeneous filter medium. Thus, compared to conventional filter media, sheet filter media of the present invention will have a lower pressure drop for any desired efficiency of particle capture or a higher particle capture efficiency for any desired pressure drop.

In alternative embodiments, many polymer blends possessing hydrophilic and hydrophobic characteristics may be used to form sheet filter media in two-phase or multiphase systems. The polymer blends may be mixtures of amorphous or crystalline polymers, homopolymers or copolymers, dead polymers mixed with reactive components (e.g. monomers, oligomers, crosslinkers and others), and viscous reactive oligomers or macromers. For example, reactions for formation of fiber networks may be of a free-radical or condensation nature. Also, the polymers or polymer precursors may be synthetic or natural. Synthetic polymers span not only hydrocarbons, such as polyolefins, polyesters, acetates, acrylics and nylons, but also fluorocarbons and silicones.

When mechanical means are employed for thin, porous sheet filter media formation, interfacial properties between the polymer/precursor systems and the roller may be exploited to make fleece-like structures. If strong but transient adhesion exists between the feed material and the shape-producing substrate surface, then fine strings or whiskers may be pulled from the filter sheet until the viscoelasticity of the material ruptures the thinning tethers between the substrate surface and the feed material. The numerous strings or whiskers thus produced may be fleece-like. In one example, subsequent curing produces locks in this fleece-like, three-dimensional architecture. Also, a highly textured sheet filter medium is produced by promoting string formation via a deliberately abraded (i.e. roughened) substrate surface that has a plurality of nanoscopic or microscopic defects. Alternatively, a highly regular and clean sheet filter medium is assured by making a defect-free surface and using a mold release agent to reduce the surface tension between the surface of the substrate and the feed material.

In another example, two mating rollers have parallel grooves with one set running across the width of the first roller and a second set spanning the circumference of the second roller. When a feed containing the precursor component is squeezed through the nip region, a crisscrossed fibrous pattern is produced. In one example, the lines are not continuous across the width of the first roller or along the circumference of the second roller. Thus, a pattern is formed that has increased flexibility. In addition, the roller surfaces may be provided with indented dots in the grooves that results in a sheet filter medium having raised points, providing enhanced tactile properties.

In another embodiment, a sacrificial layer or carrier film, such as a soluble film, is used. Patterns may be deposited by any of the methods of the invention on one or both sides of the sacrificial layer or carrier film. For example, such patterns may be multi-layered, and connections may be formed between the patterns on opposite sides of a sacrificial layer by way of “vias” that are formed through the sacrificial layer, such as by forming preexisting holes therein. After the sheet filter media are formed, the sacrificial layer may be dissolved, providing interconnects between the sheet filter medium only at specific interconnection points that corresponded to the location of vias. Thus, complex three-dimensional geometry may be formed, which are not possible using convention filter media. Alternatively, a carrier film may be simply peeled from the filter medium and reused, perhaps, reducing cost of manufacture.

In another embodiment, a semisolid film containing at least one precursor is squeezed through a set of embossed rollers having patterns embossed on the surface of each roller. For example, the patterns, such as lines and holes, are punched through the semisolid film, creating openings that may be enhanced by careful stretching of the semisolid film. Then, the precursors of the semisolid film are processed, such as by polymerization, curing, crystallization or solidification, to yield a fully solid sheet filter media, retaining the openings. For example, the semisolid film may be heated or exposed, such as to UV light, X-rays, microwaves, electron beam or gamma radiation, to fully react the semisolid film and form a solid sheet filter medium.

The term “semisolid film” refers to a film that exhibits the properties of a film under no shear forces or low shear forces, but that yields under high shear forces. Thus, the semisolid film may be handled as a solid film, but may be punched through easily by a raised surface on a roller or rollers. In one example, a semisolid film has an elastic modulus from 10⁶ dynes/cm² to 10⁷ dynes/cm². In another example, the rollers are capable of applying greater force, and the upper range of the elastic modulus was increased to be no greater than 10¹⁰ dynes/cm². For example, the elastic modulus of the semisolid film may be modified by mixing high molecular weight polymers with lower molecular weight polymers and optional diluents, plasticized polymers and partially swollen (by solvents) polymers. One or more of these constituents may be reactive one with the other, such as dead polymers having pendant functional groups that may be crosslinked by a crosslinking constituent or agent. Also, the diluents and/or plasticizers may be either completely or partially polymerized or crosslinked to form interpenetrating polymer networks (IPNs). The semi-solid film may also comprise reactive oligomers or macromers or mixtures thereof and other additives, such as antioxidants, fire retardants, mold release agents, flow aids, bioactive agents, activated charcoal, microfibrils and/or pre-existing natural and/or synthetic fibers.

In an alternative embodiment, the semisolid film does not need to be punched through mechanically by rollers. Instead, opaque regions may be deposited on one or both surfaces of the semisolid film prior to processing the film precursors to induce the film to solidify, such as by exposure to UV light. Then, the opaque regions, which did not solidify, may be preferentially dissolved to open holes in the sheet filter medium. Masks may be used to provide the opaque regions, as in standard photolithography. A mask may be prepared by coating a mylar film with a patterned metal. The patterned mylar film then imparts a shadow on the semisolid film during exposure of the semisolid film to the radiation source. For example, the radiation source may solidify the unmasked portion of the semisolid film while traversing on a conveyor. Alternatively, rapid laser scanning is another alternative for creating a pattern in the semisolid film.

In alternative embodiments, the semisolid film may be developed independently, or semisolid films may be one or more layers in a multi-layered filter medium. For example, a multi-layered film may be exposed on opposite sides simultaneously or sequentially. If one of the layers is a semisolid film, then the other layers may be deposited thereon, as for any substrate. For example, a central semi-solid film may be coated with liquid precursors on either or both sides to make a laminated, open filter structure in fewer steps than would be required for forming each layer independently. In one embodiment, the pore size progresses in size from one side of a multi-layered film to the other. Thus, a layer on a first surface of the multi-layered filter has the largest pore size, while the layer on the opposite surface has the smallest. Intermediate layers transitions from the largest to the smallest pore size in sequence from the first surface to the opposite surface, which can be used as a progressive microsieve that filters out the largest particles first. Such multi-layered filters may have the pores substantially aligned or may have the pores offset, from one layer to the next, to increase the tortuosity of the airflow path. A tortuous pathway may increase the efficiency of particle capture, but also increases the pressure drop across the filter. It is within the ordinary skill in the art to determine the arrangement that is optimal for a particular application.

In yet another method, ink-jet printing is used to deposit a pattern of fiber precursors on a surface, such as a flat surface or a curved surface. In one embodiment, multiple nozzles are simultaneously employed to rapidly deposit the precursor component on the surface. Any conceivable pattern may be printed in this manner, and different nozzles may deposit different precursors, which may be reacting or non-reacting. In addition, the method may cure the precursors, such as by using heat, light or addition of a catalyst, to fuse, polymerize or further polymerize the precursors during ink-jet printing and/or after ink-jet printing is completed. In one embodiment, the surface is a non-stick surface, and the cured sheet filter medium is removed by simply peeling the sheet filter medium from the surface. For example, a Teflon® surface, i.e. polytetrafluoroethylene (PTFE) or a substrate coated with a non-stick coating may be used. ®Teflon is a registered trademark of the Dupont Corp.

In alternative embodiments, the nozzles are oscillated or moved in a predetermined pattern to cause continuous fibrous material ejected from the nozzles to be deposited on the surface in a pattern. For example, the pattern may force the strands to cross over one another, fusing the strands together. Alternatively, the strands may be deposited in lines and then the table beneath the strands may be rotated, and a second pass made to cause a second pattern of lines to cross over the first pattern of lines. The strands may then be fused using heat or by any other method, such as crosslinking by photopolymerization. Alternatively, the process may be a continuous process that uses a conveyor belt to move the deposition surface from one set of nozzles to a next set of nozzles. Different precursor materials may be deposited by different nozzles in layers (and non-adjacent layers) that may be fused together. In one example, crisscrossed junction points are formed with some junctions being joined and other not being joined, allowing a three-dimensional structure to be formed by expanding a two-dimensional sheet filter into a third dimension. Very intricate two- and three-dimensional patterns may be formed by selectively fusing certain points between alternating layers of a filter media with multiple layers deposited by nozzles using this method.

In another method, laser printing technology is used to deposit precursors on a surface, which are then polymerized. The precursors are deposited using plates or rollers that impart a static charge to a toner to form a pattern that is then transferred to a transfer surface. The toner patter may contain the precursors or may be used to form the precursors into patterns as previously related.

In yet another embodiment, the feed also contains a blowing or foaming agent. Any conventional blowing or foaming agent may be incorporated into the fibers, themselves. Once a lace-like structure is formed, the fibrous strands are expanded, creating hollow fibers, porous fibers or a combination of the two.

The methods and advanced filter media presented herein provide for engineered micro-filter and sub-micron filter production having a specific pore size, shape and distribution, reducing pressure drop and increasing capture efficiency compared to conventional filters with randomly oriented fibers. Also, conventional filters, with random distribution of fibers, require more material to perform the same level of filtering, increasing the filter cost.

One or more of these filter media may be coated with a neutralizing component that is capable of neutralizing one or more harmful substances, such as harmful particulates, aerosols, gases, vapors and pathogens.

Advanced filters of the present invention may be used in any and all filtration systems, such as HVAC, surgical masks, protective masks, vacuum cleaner bags, sieves, medical isolation, clean rooms, transportation and industrial applications.

It is not possible to list all of the combinations that may be used to form sheet filter media. Although the present invention has been described in relation to particular embodiments and examples thereof, many other variations and modifications and other uses will be apparent to those skilled in the art. These are intended to be included within the scope of the claimed invention; therefore, it is preferred that the present invention be limited not by the specific disclosure herein, but only by the issued claims.

TABLE I
Relative Size of Harmful Substances

| Harmful Substance | Size (microns) | Capture Mechanism |
|---|---|---|
| Anthrax | 1-10 | interception |
| Virus | sub-micron | diffusion/interaction |
| Chemicals | Aerosol: 1-10 | interception |
| | Gas: 0.005 | diffusion/adsorption |

What is claimed is:

1. A filter medium for filtering a harmful substance, comprising:
a network of interconnected fibers; and
the network of interconnected fibers defines pores having a non-random, engineered pore size distribution, wherein the pore size is no greater than 50 microns.

2. The filter medium of claim 1, wherein the pore size distribution is monodisperse.

3. The filter medium of claim 1, wherein the network of interconnected fibers define a pattern of pores in a honeycomb pattern.

4. The filter medium of claim 1, wherein the network of interconnected fibers define a pattern of pores in a rectangular pattern.

5. A filter medium for filtering a harmful substance, comprising:
a network of interconnected fibers; and
a neutralizing component, wherein the neutralizing component coats at least a portion of the network of interconnected fibers.

6. The filter medium of claim 5, wherein the network of interconnected fibers is substantially coated by the neutralizing component.

7. The filter medium of claim 5, wherein the neutralizing component comprises:
a host material; and
one or more neutralizing substances.

8. The filter of claim 7, wherein the one or more neutralizing substances are selected from the group consisting of acidic substances, basic substances and oxidizing substances.

9. The filter of claim 7, wherein the host material has a tacky surface.

10. The filter of claim 7, wherein the host material is a thin layer of viscous organic components.

11. The filter of claim 7, wherein the one or more neutralizing components comprises at least one oxidizing agent.

12. The filter of claim 11, wherein the oxidizing agent is selected from the group consisting of sodium hypochlorite, calcium hypochlorite, potassium permanganate and mixtures thereof.

13. The filter of claim 7, wherein the one or more neutralizing components is selected from the group of acidic complexes consisting of acrylic acid derivatives, sulfonic acid derivatives, and mixtures thereof.

14. The filter of claim 7, wherein the one or more neutralizing components is selected from the group of basic complexes consisting of sodium alkoxides, tertiary amines, and pyridines and compatible mixtures thereof.

15. The filter of claim 5, wherein the fibers are made of a polymeric material such as poly(vinyl pyrrolidone), poly(vinyl pyridine), poly(acrylic acid) (free acid or salt), poly(styrene sulfonic acid) (free acid or salt), poly(ethylene glycol), poly(vinyl alcohol), polysiloxanes, polyacrylate derivatives, carboxymethyl cellulose, or mixtures and copolymers thereof.

16. A method of fabricating filter media, comprising:
preparing a precursor emulsion or solution;
patterning a substrate, wherein a pattern is formed on the surface of the substrate; and
contacting the substrate with the precursor emulsion or solution;
segregating at least one precursor from the emulsion or solution in the pattern on the surface of the substrate;
reacting the precursor that segregates from the emulsion or solution, forming a sheet filter media; and
removing the sheet filter media from the substrate.

17. The method of claim 16, wherein the step of patterning comprises forming ridges and grooves on the surface of the substrate.

18. The method of claim 17, wherein the separation is caused by a temperature difference.

19. The method of claim 16, wherein the surface of the substrate is substantially flat and the step of patterning is formed by dissimilar materials being deposited on the surface of the substrate.

20. The method of claim 16, wherein the step of reacting includes illuminating the precursor with a UV light source to polymerize the precursor.
